(19) United States
(12) Patent Application Publication
(10) Pub. No.: US 2023/0303206 A1
(43) Pub. Date: Sep. 28, 2023

(54) Method for Controlling a Drive of an Electric Bicycle and associated Apparatus

(71) Applicant: Robert Bosch GmbH, Stuttgart (DE)

(72) Inventors: Daniel Baumgaertner, Neustetten (DE); Merlin Martin Manewald, Reutlingen (DE)

(21) Appl. No.: 18/188,017

(22) Filed: Mar. 22, 2023

(30) Foreign Application Priority Data
Mar. 25, 2022 (DE) 10 2022 202 982.8

(51) Int. Cl. B62M 6/45

(52) U.S. Cl. CPC B62M 6/45

(57) ABSTRACT

A method for controlling a drive of an electric bicycle is disclosed. The method includes determining a first drive power describing a power supplied during a pedaling operation of a driver of the electric bicycle via a drivetrain of the electric bicycle. The method further includes actuating a motor of the electric bicycle in response to the pedaling being ended so as to supply, by way of a targeted power control, a second drive power through the motor, which is continuously less than or equal to the first drive power over a given first time interval. An apparatus for controlling a drive of an electric bicycle is also disclosed.

This application claims priority under 35 U.S.C. § 119 to patent application no. DE 10 2022 202 982.8, filed on Mar. 25, 2022 in Germany, the disclosure of which is incorporated herein by reference in its entirety.

### BACKGROUND

The present disclosure relates to a method for controlling a drive of an electric bicycle and an associated apparatus.

The drives of current electric bicycles are expected to provide optimum support for a driver, even in athletic use and in difficult travel conditions, for example for use as a mountain bike. An advantageous applied method is to continue or bank the drive for a given time even after the driver has stopped applying the pedal. This banking is triggered, for example, in the event of an abrupt reduction of a torque or a cadence of the driver with a subsequent pedal break.

It is customary to define the banking via a time-defined abatement of the torque output of the drive. The motor torque before the pedal break is maintained while decreasing over a given time after a pedal break. However, this also has disadvantages. For example, the behavior of the banking cannot be influenced by the driver or can occur in unwanted situations. For example, it is currently sufficient to trigger a banking if a pedal pressure and thus a driver torque are established by a driver while stationary. It is not necessary for the pedal to actually be moved. Thus, a low driver energy input can result in a high motor energy output. This can result in unwanted behavior of the electric bicycle or the drive of the electric bicycle, respectively.

The progression of the motor power can thus be perceived as harmonized when banking, especially if the motor speed decreases or increases significantly during the banking.

### SUMMARY

The method according to the present disclosure for controlling a drive of an electric bicycle comprises the following steps: determining a first drive power describing a power supplied during a pedaling operation of a driver of the electric bicycle via a drivetrain of the electric bicycle, and actuating a motor of the electric bicycle in response to the pedaling being ended, so as to supply, by means of a targeted power control, a second drive power through the motor, which is less than or equal to the first drive power over a given first time interval.

An apparatus according to the present disclosure for controlling a drive of an electric bicycle comprises a control unit which is configured so as to determine a first drive power describing a power supplied during a pedaling operation of a driver of the electric bicycle via a drivetrain of the electric bicycle and to actuate a motor of the electric bicycle in response to the pedaling being ended, so as to supply, by means of a targeted power control, a second drive power through the motor, which is continuously less than or equal to the first drive power over a given first time interval.

Thus, a banking by a drive of the electric bicycle after a termination of a pedaling operation is supplied. A pedaling operation is an operation in which a driver cadence or driver torque is present. A driver cadence is defined by a movement of the pedals by the driver of the bicycle and a driver torque by an application of a torque to the pedals by the driver of the bicycle.

The first drive power is a power supplied by the driver of the electric bicycle and/or the motor of the electric bicycle. In particular, the power is calculated based on a measured torque and a measured speed, wherein the power results from a multiplication of torque and speed. Alternatively, the motor torque is determined, in particular computationally, based on a filtered driver torque and a support factor. The driver torque or the driver torque is preferably sensed by measurement technology. If the first drive power results from a combination of a power supplied by the motor and a power supplied by the driver, then these powers are added.

The actuation of the motor of the electric bicycle in order to supply the second drive power through the motor occurs in response to the pedaling operation having been ended. In so doing, the second drive power supplied is selected such that it is less than or equal to the first drive power. The banking is thus controlled on a power basis. The subsequent banking is thus no longer controlled exclusively on the filtered driver torque that is present before a pedal break, but rather a power regulation is carried out. The power output of the motor is controlled during the banking rather than letting a motor torque dissipate. This can be done depending on different parameters, but is preferably performed by maintaining or reducing in a defined manner the system power during the banking, in particular the driver power plus the motor power, immediately prior to the end of the pedaling operation.

Both the method according to the disclosure and the apparatus according to the disclosure lead to a more harmonic and predictable behavior of a banking after completion of a pedaling operation.

Preferred further developments of the disclosure are set forth below.

Preferably, the motor is actuated such that the second drive power is equal to the first drive power over the given first time interval and abates following the given first time interval. Thus, a pre-existing drive power is maintained, even when a pedaling operation is ended by the driver. This is particularly advantageous when the driver is expected to continue pedaling within the first time interval. A transition over a pedal break can thus be designed in a particularly harmonic manner.

Further, it is advantageous when the motor is actuated such that the second drive power continuously abates over the given first time interval. Thus, a sudden drop in power can be avoided and the pedaling operation can still be resumed by the driver without this leading to performance gains.

Also, it is advantageous for the first drive power to be a power supplied by the motor of the electric bicycle. In this case, the drive power can in particular be calculated by multiplying a motor speed by the supplied motor torque.

Alternatively, it is advantageous when the first drive power results from a motor power supplied by the motor of the electric bicycle together with the pedaling power supplied by the driver of the electric bicycle. It is thus advantageous when the first drive power is a power supplied by the overall system and exerted on the drivetrain. The pedaling power supplied by the driver of the electric bicycle is in particular a result of a multiplication of a driver torque applied to the pedals of the bicycle and a driver cadence. The motor power is in particular added to the pedaling power in order to determine the overall power of the system and thus the first drive power. This enables the power available for the forward drive of the bicycle to be precisely maintained during the banking.

It is also advantageous when, during the determination of the first drive power, a power last supplied during the pedaling operation via the drivetrain of the electric bicycle is determined. It is thus ensured that there are no jumps in the supplied power after the end of the pedaling operation and at the start of the first time interval.

Further preferably, the method further comprises a determination of a pedaling power supplied by the driver of the electric bicycle during the pedaling operation and a selection of a duration of the first time interval based on the determined pedaling power, wherein the duration of the first time interval increases with increasing pedaling power. This means, accordingly, that the duration of the first time interval abates with decreasing pedaling power. In other words, the duration of the time interval is thus proportional to the determined pedaling power. Thus, especially at high pedaling power, the banking is supplied over a longer time interval. Among other things, it is thus avoided that a long-lasting banking is triggered by a short application of a driver torque.

It is particularly advantageous when the determination of the pedaling power comprises an averaging and/or filtering of a measured pedaling power. Thus, the pedaling power is typically a fluctuating value, because the power is not continuously transferred to the pedals by a driver. With the averaging or filtering, such fluctuations can be balanced. The filter is in particular selected such that it filters the fluctuations occurring by a typical pedal frequency. The averaging of the pedaling power also means that a short supply of pedaling power cannot lead to a long-term banking.

### BRIEF DESCRIPTION OF THE DRAWINGS

Embodiment examples of the disclosure are described in detail below with reference to the accompanying drawing. The drawing shows:

FIG. 1 a flow diagram of a method according to the disclosure for controlling a drive of an electric bicycle,

FIG. 2 a schematic illustration of a bicycle comprising an apparatus according to the disclosure for controlling an electric bicycle,

FIG. 3 an illustration of a temporal progression of a driver torque, a bicycle cadence, a driver power, and a motor power in a drive of an electric bicycle controlled according to the present disclosure, and

FIG. 4 an illustration of a temporal progression of a driver torque, a driver cadence, a motor torque, a motor speed, and a motor power in a conventional control of a drive of an electric bicycle.

### DETAILED DESCRIPTION

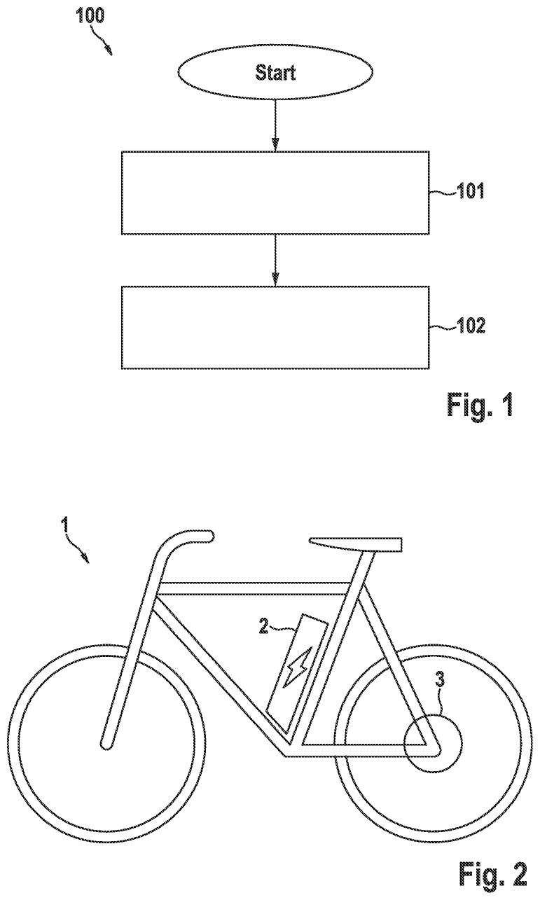

FIG. 1 shows a flow diagram of a method 100 according to the disclosure for controlling a drive of an electric bicycle 1. The associated electric bicycle 1 is shown in FIG. 2 and comprises a control unit 2 configured so as to perform the method 100. The bicycle 1 is an e-bike, which has a sensor system for a driver torque and/or a driver cadence.

The method 100 according to the disclosure comprises a first step 101 and a second step 102, which is carried out after the first step 101.

In the first step 101, a first drive power 31 is determined, which, during a pedaling operation of a driver of the electric bicycle 1, describes a power supplied via a drivetrain of the electric bicycle 1. The pedaling operation of the driver of the electric bicycle 1 is present for as long as the pedals of the electric bicycle 1 are moved by the driver or a torque is exerted by the driver. If the driver stops pedaling, the pedaling is considered to be finished.

The first drive power 31 is a drive power supplied by a motor 3 of the electric bicycle 1. Alternatively, the first drive power is a power resulting from a motor power supplied by the motor 3 of the electric bicycle 1 together with the pedaling power supplied by the driver of the electric bicycle.

The motor power supplied by the motor of the electric bicycle 1 is in particular calculated based on a measured motor speed and a measured motor torque. In this case, the first drive power 31 results from a multiplication of the motor speed measured during the pedaling operation and the motor torque measured during the pedaling operation. It should be noted that both the motor speed and motor torque may not necessarily be directly measured, but can also be calculated based on other measured values or operating parameters. Preferably, if the first drive power 31 is determined from the motor power supplied by the motor 3 of the electric bicycle 1 along with the pedaling power supplied by the driver of the electric bicycle 1, then the pedaling power supplied by the driver of the electric bicycle 1 is calculated based on a measured driver cadence and measured driver torque. Preferably, the driver cadence is multiplied by the driver torque. Both the driver torque exerted by the driver on the pedals of the electric bicycle 1 and the driver cadence, i.e. the present pedal speed, are preferably sensed by measurement technology. A combination of the previously described alternatives is also advantageous, wherein, for example, the pedaling power supplied by the driver is only included in the first drive power if it is not significantly lower than the motor power.

When determining the first drive power 31, the power last determined during the pedaling operation and supplied via the drivetrain of the electric bicycle 1 is sensed as the first drive power 31. It is thus sensed which power was supplied via the drive of the electric bicycle 1 immediately before the pedaling operation is ended by the driver of the electric bicycle 1.

When the driver ends or at least discontinues the pedaling operation, the second step 102 is performed. In the second step 102, the motor 3 of the electric bicycle 1 is actuated in response to the pedaling operation having been ended. The motor 3 is actuated such that a second drive power 32 is supplied by the motor 3, which is continuously less than or equal to the first drive power over a given first time interval 21. The actuation of the motor 3 is carried out, for example, by adjusting a supply voltage of the motor 3 as part of a power control. To ensure that the power supplied by the motor 3 is continuously less than or equal to the first drive power 31 during the first time interval 21, the motor power supplied by the motor 3 is continuously sensed or calculated.

The motor power of the motor 3 is controlled in a targeted manner in the first time interval. The motor 3 is thus preferably actuated such that the second drive power 32 is equal to the given first drive power 31 over the given first time interval 21 and does not abate until after the given first time interval 21. This means that the motor power supplied by the motor 3 is preferably maintained continuously even after the completion of a pedaling operation.

Alternatively, the motor 3 is actuated such that the second drive power 32 continuously abates over the given first time interval 21. This means that preferably the motor power supplied by the motor 3 is continuously reduced. This is preferably carried out such that, at an end of the first time interval 21, the motor power supplied by the motor 3 assumes the value of zero.

Thus, upon completion of the pedaling operation, a motor power of the motor 3 is regulated up to the value of the second drive power 32 based on an already present motor power or alternatively based on an already present motor power plus pedaling power. A power regulation of the motor 3 is thus carried out in response to a pedaling operation having been ended.

Because the motor power supplied by the motor 3 results from the supplied motor speed and the supplied motor torque, this can result in a different behavior of the motor 3. If the speed of the motor 3 increases, the motor torque will abate. If the motor speed of the motor 3 is decreased, this will result in an increase in motor torque. If the motor speed remains the same, the motor torque is also maintained unchanged. In any case, it is thus prevented that a high motor speed is supplied as the motor torque increases, which is typically perceived as unexpected and unharmonious.

The duration of the given first time interval 21 can be set in a different manner. For example, the first time interval 21 is predefined at a fixed time interval. Alternatively, the first time interval 21 is determined variably. Thus, in particular, a determination of a pedaling power supplied by the driver of the electric bicycle 1 during the pedaling operation is carried out. The pedaling power is in particular a pedaling power averaged over a predefined time interval of the driver of the electric bicycle 1 or a value resulting from a filtering of a measured pedaling power. Thus, the pedaling power supplied by the driver is typically a variable value that can be changed with the pedal position. It is thus advantageous to form an average value or to filter the fluctuations resulting from the pedal frequency. This prevents the unwanted selection of maximum or minimum values. The duration of the first time interval 21 is selected based on the determined pedaling power, wherein the duration of the first time interval 21 increases with increasing pedaling power.

By ensuring that the pedaling power is an average value over a predefined time interval, it can be prevented that individual high peaks in the temporal progression of the pedaling power, which however only last over a very short period of time, lead to a long supply of the second drive power 32 by the motor 3. Only when a supplied pedaling power continues over the predefined interval does this also result in an extension of the first time interval. A high sensed pedaling power results in a high duration of the first time interval 21, i.e. a longer supply of the second drive power 32 by the motor 3. A comparatively long subsequent banking by the motor 3 is thus carried out. Thus, for example, it is achieved that a longer banking is carried out by the motor 3, especially on mountain routes, wherein, for example, a necessary descent by the driver is prevented. Conversely, when going downhill, there is little pedaling power supplied by the driver and thus the duration of the first time interval 21 is selected comparatively short. Thus, only a short banking by the motor 3 takes place, because this is typically not required.

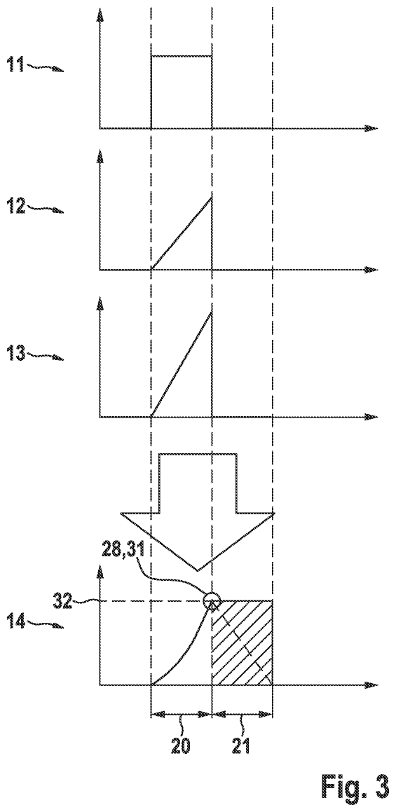

FIG. 3 shows an exemplary behavior of a control of the drive of the electric bicycle according to the disclosure. In FIG. 3, a temporal progression of a driver torque is shown in a first diagram 11. A second diagram 12 shows a temporal progression of a driver cadence, i.e. a pedal speed of the driver 1. A third diagram 13 shows a temporal progression of the driver power, i.e. the pedaling power supplied by the driver 1. In a fourth diagram 14, the motor power supplied by motor 3 is shown over a temporal progression. The first to fourth diagrams 11 to 14 show the same time temporal range. The first time interval 21 is shown, which immediately follows a preceding time interval 20 in which a pedaling operation is performed by the driver. It can be seen that in the preceding time interval 20, the power supplied via the drivetrain of the electric bicycle 1 increases up to the first drive power 31. This is continuously maintained over the first time interval 21. In the first time interval 21, the second drive power 32 is supplied by the motor 3 via the drivetrain of the electric bicycle 1. The fourth diagram 14 further shows that the second drive power 32 can also be selected such that it abates continuously in any curve shape, but preferably linearly, over the first time interval 21. This progression of the second drive power is shown by a dotted line in the fourth diagram 14.

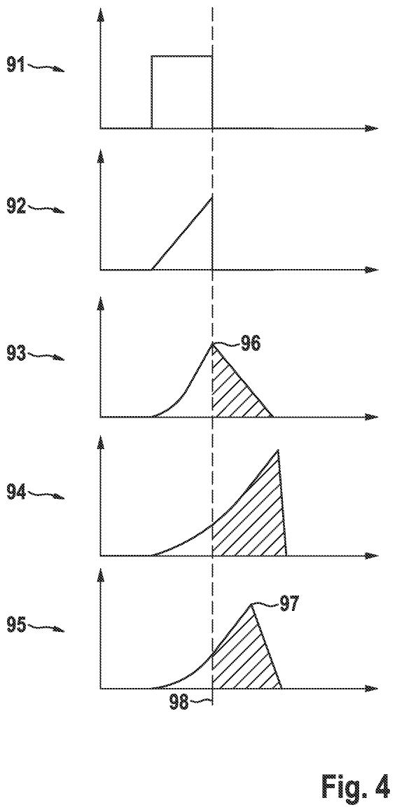

FIG. 4 shows an operation of a drive of an electric bicycle, which is however not controlled according to the method 100 according to the disclosure. The system behavior shown in FIG. 4 serves only to illustrate advantages that arise from the method according to the disclosure when compared to the actuation of a motor based on a motor torque.

FIG. 4 shows a temporal progression of a driver torque 91, a temporal progression of a driver cadence 92, a temporal progression of a motor torque 93, a temporal progression of a motor speed 94, and a temporal progression of a motor power 95. A driver pedal operation is terminated at a time 98. In order to enable the motor 3 to be banked, the motor torque is actuated such that it abates linearly. This linear abatement 96 can be seen from the temporal progression of the motor torque 93. However, an actuation of the motor accordingly results in a simultaneous increase in the supplied motor power as the motor speed increases. Thus, a delayed maximum power output by the motor of the electric bicycle occurs. This behavior is perceived as being unharmonious and unexpected by a driver of the bicycle.

Thus, FIG. 4 shows that the maximum power output is only delayed during the banking when the speed increases during the banking (because the wheel usually accelerates). This is unexpected for the driver and has an unharmonious effect. In addition, it can be seen that the motor torque supplied during the banking is independent of the cadence of the banking. The driver must only apply torque, e.g. with the brake pulled. If the bicycle can be abruptly set in motion during banking, the motor speed will speed up and a surprisingly high energy will be output for the driver.

According to the disclosure, the subsequent banking of the bicycle 1 is controlled on the other hand in a power-based manner. In addition, the banking power can depend on the driver power before the pedal break. The power output of the motor is controlled during the banking rather than simply letting the motor torque dissipate. This can be done as a function of all possible parameters, but the system power (driver+motor) directly before the banking is sensibly maintained or reduced in a defined manner as much as possible during the banking.

During banking, the (filtered/average) motor power is maintained and/or allowed to subside prior to banking. This results in a more harmonious and predictable banking for the driver. In addition, as a further improvement, the overall power from the driver and motor power can be determined prior to the banking and maintained as much as possible during banking by the motor. In addition, the power output can be made dependent on the (filtered/average) driver power prior to banking. In particular, the duration of the power output when banking can be proportional to the driver power before banking. Thus, it is no longer possible to trigger a banking by a mere pedal pressure without simultaneous pedal movement.

In addition to the above disclosure, reference is explicitly made to the disclosure of FIGS. 1 and 4.

What is claimed is:

1. A method for controlling a drive of an electric bicycle, comprising:
determining a first drive power describing a power supplied during a pedaling operation of a driver of the electric bicycle via a drivetrain of the electric bicycle; and
actuating a motor of the electric bicycle in response to the pedaling being ended so as to supply, by way of a targeted power control, a second drive power through the motor, which is continuously less than or equal to the first drive power over a given first time interval.

2. The method according to claim 1, wherein the motor is actuated such that the second drive power is equal to the first drive power over the given first time interval and abates subsequent to the given first time interval.

3. The method according to claim 1, wherein the motor is actuated such that the second drive power continuously abates over the given first time interval.

4. The method according to claim 1, wherein the first drive power is a power supplied by the motor of the electric bicycle.

5. The method according to claim 1, wherein the first drive power results from a motor power supplied by the motor of the electric bicycle together with the pedaling power supplied by the driver of the electric bicycle.

6. The method according to claim 1, wherein:
when the first drive power is determined, a power last supplied during the pedaling operation via the drivetrain of the electric bicycle is determined.

7. The method according to claim 1, further comprising:
determining a pedaling power supplied by the driver of the electric bicycle during the pedaling operation, and
selecting a duration of the first time interval based on the determined pedaling power,
wherein the duration of the first time interval increases with increasing pedaling power.

8. The method according to claim 7, wherein the determination of the pedaling power comprises an averaging and/or filtering of a measured pedaling power.

9. An apparatus for controlling a drive of an electric bicycle, comprising a control unit which is configured to:
determine a first drive power describing a power supplied during a pedaling operation of a driver of the electric bicycle via a drivetrain of the electric bicycle, and
actuate a motor of the electric bicycle in response to the pedaling operation having been ended in order to supply, by way of a targeted power control, a second drive power through the motor, which is continuously less than or equal to the first drive power over a given first time interval.
